(19) United States
(12) Patent Application Publication
(10) Pub. No.: US 2026/0193085 A1
(43) Pub. Date: Jul. 9, 2026

(54) ACTIVATED CARBON PRODUCTION FOR SELECTIVE CARBON DIOXIDE CAPTURE

(71) Applicant: King Fahd University of Petroleum and Minerals, Dhahran (SA)

(72) Inventors: Hamza Abbas Hamza ASMALY, Dhahran (SA); Abbas Saeed HAKEEM, Dhahran (SA); Abdullah KHALIL, Mississauga (CA); Akolade Idris BAKARE, Dhahran (SA)

(73) Assignee: King Fahd University of Petroleum and Minerals, Dhahran (SA)

(21) Appl. No.: 19/013,115

(22) Filed: Jan. 8, 2025

(51) Int. Cl. C01B 32/318

(52) U.S. Cl. CPC C01B 32/318; C01P 2002/70; C01P 2004/60; C01P 2006/12; C01P 2006/14; C01P 2006/16

(57) ABSTRACT

A method of preparing activated carbon (AC) from seed shells of Balanites aegyptiaca comprising: comminuting the seed shells to form a powder having a particle size of about 50 mesh to about 300 mesh; admixing the powder with solid state potassium hydroxide (KOH) at a ratio by weight of KOH powder of about 1.5:1 to about 2.5:1; forming a slurry of the obtained mixture in water under stirring for a duration of from about 1 hour to about 5 hours; drying the obtained slurry and deagglomerating the residual solid fraction thereof; subjecting the deagglomerated solid fraction to carbonization by heating said fraction under an inert atmosphere; and, cooling and neutralizing the product of said carbonization.

### STATEMENT OF PRIOR DISCLOSURE BY INVENTOR

Aspects of the present disclosure are described in Asmaly et al. “Capturing CO₂ through High Surface Area Activated Carbon Derived from Seed Shells of Balanites Aegyptiaca”, Chemistry: An Asian Journal, 2024, incorporated herein by reference in its entirety.

### STATEMENT OF ACKNOWLEDGEMENT

Support provided by the Interdisciplinary Research Center for Hydrogen Technology and Carbon Management (IRC-HTCM) at King Fahd University of Petroleum and Minerals (KFUPM) is gratefully acknowledged.

### BACKGROUND

### Technical Field

The present disclosure is directed towards a method for producing activated carbon, and more particularly, towards a method of forming an activated carbon from Balanites aegyptiaca which has utility in selective carbon dioxide capture.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

The increasing global temperature due to the surge in industrial development has led to a growing concern about carbon dioxide (CO₂) emissions. Presently, research is underway to develop materials and methods that may effectively sequester CO₂. There are several techniques for capturing (CO₂) to reduce its concentration in the atmosphere. Post-combustion capture is a technique that involves removing CO₂ from exhaust gases after fossil fuels are burned, typically using solvents or absorbents like amines to selectively capture the CO₂. Pre-combustion capture occurs before combustion, where fuels are converted into hydrogen and CO₂, allowing the CO₂ to be separated and stored. Oxy-fuel combustion uses pure oxygen instead of air to burn fuel, producing a flue gas that is mostly CO₂ and water vapor, making CO₂ capture easier. Further, direct air capture (DAC) is a method where CO₂ is captured directly from the atmosphere through chemical processes using either solid sorbents or liquid solvents. Mineral carbonation involves reacting CO₂ with naturally occurring minerals to form stable carbonates, providing a potential solution for long-term CO₂ storage. Each method has its own set of advantages, challenges, and potential for scalability, and a combination of techniques may be needed to effectively address global CO₂ emissions.

Although several technologies exist for separating and capturing CO₂, adsorption is an efficient approach due to ease of implementation and cost-effectiveness. Adsorption allows for enhanced CO₂ capture and convenient regeneration of adsorbents during operational lifetime. Adsorption techniques for CO₂ capture involve the use of solid materials, known as adsorbents, to attract and hold CO₂ molecules on their surface. Adsorption materials are typically porous and have a large surface area, which enhances the ability to adsorb CO₂. A variety of natural and synthetic adsorbents are available for customization and implementation of a CO₂-capturing system: mention may be made of zeolites, metal-organic frameworks (MOFs), amine-functionalized adsorbents and silica-based adsorbents. Zeolites, for example, are crystalline materials with a regular, well-defined pore structure: they adsorb CO₂ through a combination of physical and chemical interactions, with the ability to selectively capture CO₂ over other gases like nitrogen or oxygen. Metal organic frameworks (MOFs) are a class of materials consisting of metal ions or clusters coordinated to organic ligands, forming a highly porous structure: the frameworks show high CO₂ adsorption abilities due to both pore size and surface functionality, and may adsorb CO₂ at both low and high pressures. Amine-functionalized adsorbents are materials are modified with amine groups, which chemically react with CO₂ to form carbamate bonds.

Chemical adsorption process may capture CO₂ more effectively than physical adsorption, especially at lower CO₂ concentrations, and is often used in temperature swing adsorption (TSA) processes, wherein heating is applied to release the captured CO₂. Silica-based adsorbents are mesoporous silica and silicate-based composites which may adsorb CO₂ through weak physical interactions: the functionality of these materials may be modified to enhance their CO₂ uptake and selectivity.

The aforementioned adsorption techniques are typically used in applications such as air capture, industrial CO₂ separation, and natural gas purification. The effectiveness of the adsorbent depends on factors like the surface area and porosity of the material, the temperature and pressure conditions, as well as the specific interactions between CO₂ and the material. However, the above defined materials and methods have a certain set of drawbacks. Zeolites may have high selectivity but suffer from limited CO₂ capacity and excessive cost. MOFs are expensive to produce and may degrade over time. Amine-functionalized adsorbents may experience degradation and high energy costs during regeneration, limiting efficiency. Thus, whilst many such technologies and processes have been developed to tackle the above stated problem of carbon capture, there is still a requirement for low-cost adsorbents, preferably synthesized from environmentally friendly sources.

Hence, each of the aforementioned methods and materials suffers from one or more drawbacks hindering their adoption. Accordingly, one object of the present disclosure is to provide an activated carbon for CO₂ capture from a plant, which may circumvent certain drawbacks known in the art, such as poor sustainability, low efficiency, and high-cost factors of the previously used materials.

### SUMMARY

In an exemplary embodiment, a method of preparing activated carbon (AC) from seed shells of Balanites aegyptiaca is described. The method comprises: comminuting the seed shells to form a powder having a particle size of from about 50 mesh to about 300 mesh; and, admixing the powder with solid state potassium hydroxide (KOH) at a ratio by weight of KOH to powder of from about 1.5:1 to about 2.5:1. The method further comprises: forming a slurry of the obtained mixture in water under stirring for a duration of from about 1 hour to about 5 hours; drying the obtained slurry; deagglomerating the residual solid fraction thereof; and, subjecting the deagglomerated solid fraction to carbonization by heating said fraction under an inert atmosphere. The heating includes a first isothermal heating stage in which the fraction is maintained at a temperature in the range of from about 400° C. to about 600° C. for a duration of from about 0.5 hours to about 2 hours. The heating further includes a subsequent second isothermal heating stage in which the fraction is maintained at a temperature in the range of about 750° C. to about 1000° C. for a duration of from about 0.5 hours to about 2 hours. After heating, the method includes cooling and neutralizing the product of said carbonization.

In some embodiments, the ratio by weight of KOH to powder is from about 1.8:1 to about 2.2:1.

In some embodiments, the ratio by weight of KOH to powder is about 2:1.

In some embodiments, the molarity of KOH in the slurry is from about 1 mole per liter to about 3 moles per liter.

In some embodiments, the molarity of KOH in the slurry is from about 1 mole per liter to about 2 moles per liter.

In some embodiments, the first isothermal heating stage reduces the incidence in the heated fraction of crystalline phases attributable to potassium carbonate (K₂CO₃) and/or potassium bicarbonate (KHCO₃), as determined by X-ray diffraction (XRD).

In some embodiments, in the first isothermal heating stage, the heated fraction is kept at a temperature in the range of from about 450° C. to about 550° C. for a duration of from about 0.5 hours to about 1.5 hours.

In some embodiments, in the second isothermal heating stage, the heated fraction is maintained at a temperature in the range of from about 800° C. to about 900° C. for a duration of from 0.5 hours to 1.5 hours.

In some embodiments, between the first and second isothermal heating stages, the temperature of the heated fraction is increased at a rate of from about 5° C. to about 15° C. per minute.

In some embodiments, the product of carbonization is neutralized by rinsing the product with an aqueous hydrochloride (HCl) solution and subsequently with deionized (DI) water.

In some embodiments, an activated carbon is obtained by the above described method, wherein the activated carbon has: a surface area of from about 2500 square meters per gram (m²/g) to about 3500 m²/g, as determined by Brunauer-Emmett-Teller (BET) analysis; a median pore diameter of about 4.0 nanometers (nm) to about 5.0 nm, as determined by Barrett-Joyner-Halenda (BJH) desorption analysis; and, a pore volume of from about 0.2 cubic centimeter per gram (cm³/g) to about 0.5 cm³/g as determined by BJH desorption analysis.

In some embodiments, the activated carbon has: a surface area of from about 2800 m²/g to about 3200 m²/g, as determined by BET analysis; a median pore diameter of from about 4.0 nm to about 4.5 nm, as determined by BJH desorption analysis; and, a pore volume of from about 0.3 cm³/g to about 0.4 cm³/g, as determined by BJH desorption analysis.

In some embodiments, the total weight loss of the activated carbon (AC), as determined by thermogravimetric analysis (TGA) in accordance with ASTM E1131, is less than about 90 weight percent (wt. %) when the activated carbon is heated from about 100° C. to about 1000° C. at a heating rate of about +10° C. per minute.

In some embodiments, the total weight loss of the activated carbon (AC), as determined by TGA in accordance with ASTM E1131, is less than about 85 wt. % when the AC is heated from about 100° C. to about 750° C. at a heating rate of about +10° C. per minute.

In some embodiments, the intensity ratio of the D peak to the G peak (I_{D}/I_{G}), as determined by Raman spectroscopic analysis, is from about 0.90 to about 1.00.

In some embodiments, the activated carbon (AC) has a N₂ absorption capacity of at least about 0.8 mmol/g, as determined by volumetric analysis at a temperature of about 0° C. and a N₂ pressure of 0.1 MPa.

In some embodiments, the activated carbon (AC) has a methane (CH₄) absorption capacity of at least about 1.5 mmol/g, as determined by volumetric analysis at a temperature of about 0° C. and a CH₄ pressure of 0.1 MPa.

In some embodiments, the activated carbon (AC) has a CO₂ absorption capacity of at least about 10.0 mmol/g as determined by volumetric analysis at a temperature of about 0° C. and a CO₂ pressure of 0.1 MPa.

In another exemplary embodiment, a method for adsorbing CO₂ from a fluid including that compound is described. The method includes contacting the fluid source with the activated carbon (AC).

In some embodiments, the fluid includes a flue gas.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of forming an activated carbon (AC), according to certain embodiments.

FIG. 2A shows a field emission electron scanning microscopy (FESEM) image of an activated carbon (AC) A (500-850), according to certain embodiments.

FIG. 2B shows a FESEM image of an activated carbon (AC) A (850), according to certain embodiments.

FIG. 2C shows a FESEM image of an activated carbon (AC) B (500-850), according to certain embodiments.

FIG. 2D shows a FESEM image of an activated carbon (AC) B (850), according to certain embodiments.

FIG. 3A shows thermogravimetric analysis (TGA) results for the certain activated carbon (ACs), according to certain embodiments.

FIG. 3B shows X-ray diffraction (XRD) analysis results for the ACs, according to certain embodiments.

FIG. 4A shows N₂ adsorption/desorption isotherms for type-A activated carbon (ACs), according to certain embodiments.

FIG. 4B shows N₂ adsorption/desorption isotherms for type-B activated carbon (ACs), according to certain embodiments.

FIG. 5A shows Barrett-Joyner-Halenda (BJH) pore size distributions for type-A activated carbon (ACs) and type-B activated carbon (ACs), according to certain embodiments.

FIG. 5B shows Raman spectra of type-A activated carbon (ACs) and type-B activated carbon (ACs), according to certain embodiments.

FIG. 6A shows gas uptake and selectivity of a type-B (500-850) activated carbon (AC) for different gases at 0° C., according to certain embodiments.

FIG. 6B shows gas uptake and selectivity of a type-B (500-850) activated carbon (AC) for different gases at 15° C., according to certain embodiments.

FIG. 6C shows gas uptake and selectivity of a type-B (500-850) activated carbon (AC) for different gases at 25° C., according to certain embodiments.

FIG. 7 shows cyclic CO₂ uptake of a type-B (500-850) activated carbon (AC) at 0° C., according to certain embodiments.

### DETAILED DESCRIPTION

As used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

Within the description of this disclosure, where a numerical limit or range is stated, all values and subranges within that numerical limit or range are specifically included as if explicitly written out.

As used herein, the term ‘particle’ refers to a small object that acts as a whole unit with regard to its transport and properties. It is envisaged herein that particles of the present activated carbon that are fibrous, acicular, spherical, ellipsoidal, cylindrical, bead-like, cubic or platelet-like may be present alone or in combination. Moreover, it is envisaged that agglomerates of particles having the same or different morphologies may be present in the activated carbon.

Unless otherwise stated, the term “particle size” refers to the largest axis of the particle. In the case of a generally spherical particle, the largest axis is the diameter.

The term “median volume particle size” (Dv50), as used herein, refers to a particle size corresponding to 50% of the volume of the sampled particles being greater than and 50% of the volume of the sampled particles being smaller than the recited Dv50 value. Particle size is determined herein by Scanning Electron Microscopy (SEM).

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopically labelled compounds of the disclosure may generally be prepared by conventional techniques known to those skilled in the art or by processes analogous to those described herein, using an appropriate isotopically-labelled reagent in place of the non-labelled reagent otherwise employed.

As used herein, “adsorption” is the adhesion of atoms, ions or molecules from a gas, liquid, or dissolved solid to a surface. The process creates a film of an adsorbate (e.g. the first gas) on the surface of an adsorbent (e.g. the fluorinated carbon adsorbent).

The term “chemisorption” may also be referred to as chemical adsorption. The term encompasses adsorption in which the forces involved are valence forces of the same kind as those operating in the formation of chemical compounds. Chemisorption is characterized by chemical specificity.

It is envisaged, for example, that particles of the present activated carbon that are fibrous, acicular, spherical, ellipsoidal, cylindrical, bead-like, cubic or platelet-like may be present alone or in combination. Moreover, it is envisaged that agglomerates of particles having the same or different morphologies may be present in the activated carbon.

As used herein, the term ‘activated carbon’ references a carbonaceous adsorbent having a developed internal pore structure. While activated carbon generally is formed from amorphous (non-graphitic) carbon, activated carbon may also be formed from non-amorphous carbon, such as carbon nanotubes.

As used herein, ‘carbonization’ describes a process of taking a precursor material and heating it to an elevated temperature and for an effective amount of time to sufficiently carbonize the mixture to produce a carbonized body. The carbonizing atmosphere should not typically not contain oxygen, as said oxygen will react with carbon and remove material from the carbonized body.

As used herein, ‘activation’ references a process in which a carbonized precursor is treated with an agent—conventionally an oxidizing agent—to permit the development of a desired pore structure in the activated carbonized body. During activation, some of the carbon can be reacted with the oxidizing agent to form pores of various sizes in the activated carbon.

The term ‘isothermal’ is used herein to qualify the performance of a stated action—such as a heating step or a cooling step of a process—at a substantially constant temperature.

Aspects of the present disclosure are directed to a method of converting agricultural waste, the seed shells of Balanites aegyptiaca, to activated carbon. The method takes into consideration two critical factors for optimizing the desired properties in the activated carbon, namely, biomass to KOH ratio, and multi-stage carbonization. The activated carbon prepared by the method of present disclosure was further evaluated for its potential in CO₂ uptake capacity, and the results indicate that this activated carbon of the present disclosure surpassed the uptake capacity of previously reported activated carbons. The selectivity towards CO₂ was also found to be significantly higher compared to other gases, such as nitrogen and methane-suggesting that the activated carbon can be used for capturing CO₂ and other environmental contaminants.

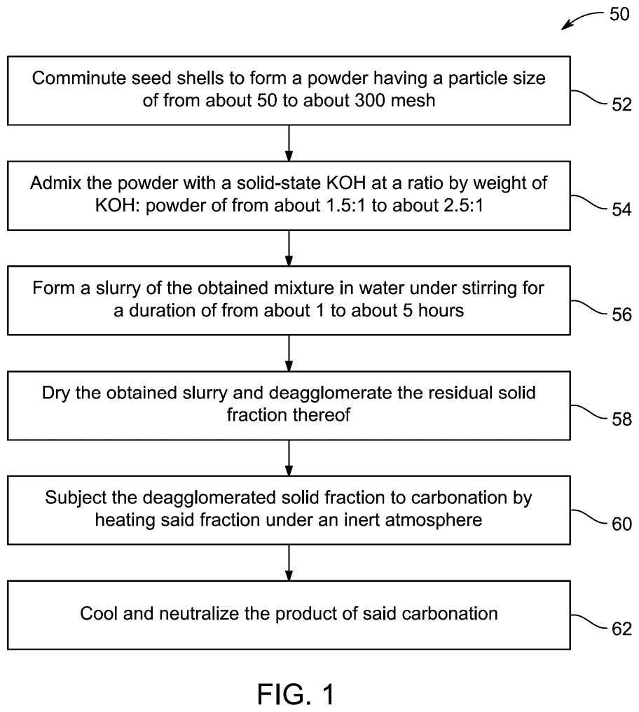

FIG. 1 illustrates a schematic flow chart of a method 50 of preparing activated carbon from seed shells of Balanites aegyptiaca. Although the description provided herein refers to the use of Balanites aegyptiaca (L.) Delile, it may be understood by a person skilled in the art that other Balanites, such as Balanites angolensis, Balanites glabra, Balanites maughamii, Balanites pedicellaris, Balanites rotundifolia, Balanites roxburghii, Balanites triflora, Balanites wilsoniana, and/or combinations thereof may have utility in the present disclosure The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes comminuting the seed shells to form a powder having a particle size of from about 50 to about 300 mesh. As used herein, ‘comminuting’ refers to process of reducing the average size of solid materials into smaller particles, by crushing, grinding, cutting, vibrating, or other processes. Comminuting may serve, in certain embodiments, to reduce the median volume particle size of the original seed shells by at least about 80%, for example at least about 85%, at least about 90% or at least about 95%.

In some embodiments, the raw materials to prepare the activated carbon comprise at least 50, 60, 70, 75, 80, 85, 90, 91, 92, 92.5, 93, 94, 95, 96, 97, 97.5, 98, 99, 99.1, 99.5, or 99.9 wt. % of seed shells of Balanites aegyptiaca. The seed shells are ground into a fine powder either manually or mechanically using a grinder, blender or mixer for example, to obtain a powder having a particle size of from about 50 to about 300 mesh.

At step 54, the method 50 includes admixing the powder with solid state potassium hydroxide (KOH) at a ratio by weight of KOH: powder of from about 1.5:1 to about 2.5:1, preferably about 1.8:1 to about 2.2:1, and more preferably about 2:1. KOH is used as an activating agent in the conversion of the powdered seed shells of Balanites aegyptiaca to activated carbon. In some embodiments, other chemical activating agents like phosphoric acid (H₃PO₄), sulfuric acid (H₂SO₄), potassium hydroxide (KOH), potassium carbonate (K₂CO₃), and zinc chloride (ZnCl₂), may be used alone or in combination with KOH. While it is preferred to use solid state KOH, an aqueous solution of the same might also be used.

At step 56, the method 50 includes forming a slurry of the obtained mixture in water under stirring for a duration of from about 1 to about 5 hours, for example from about 1 to about 4 hours, from about 1.5 to 3 hours, from about 1.5 to about 2.5 hours, or about 2 hours. The water may be tap water, distilled water, double-distilled water, deionized water, deionized distilled water, reverse osmosis water, and/or some other water. In a preferred embodiment, the water is distilled water. In some embodiments, the concentration of KOH in the slurry is in the range of from about 1 to about 3 moles per litre (M), for example from about 1 to about 2.5 M, or from about 1 to about 2 M.

At step 58, the method 50 includes drying the obtained slurry to remove water therefrom: this typically results in the formation of an agglomerated solid and thus step 58 also comprises deagglomerating the residual solid fraction thereof. The obtained slurry may be dried by heating said slurry: to a temperature range of from about 60 to 100° C., for example from about 65 to about 95° C., from about 70 to about 90° C., from about 75 to about 85° C., or about 80° C.; for a duration of from about 24 to about 96 hours, for example from about 30 to about 80 hours, from about 50 to about 75 hours, from about 60 to about 75 hours, from about 70 to about 75 hours, or about 72 hours. Drying is carried out using heat dryers, such as rotary dryers, belt dryers, or tray dryers. The use of vacuum drying and spray drying is also not precluded however. The moisture content of the agglomerated solid is preferably less than 50 wt. %, for example less than 45 wt. %, less than 40 wt. %, less than 35 wt. %, less than 30 wt. %, based on the weight of the solid.

To effect deagglomeration, the agglomerated solid is subjected to milling, grinding, ball milling, pulverizing, crushing, pounding, fragmenting, or another technique that may be used to reduce to deagglomerate the particles to smaller particles (deagglomerated solid fraction). In some embodiments, the grinding may take place using a mill, ball mill, rod mill, autogenous mill, semi-autogenous grinding mill, pebble mill, buhrstone mill, burr mill, tower mill, vertical shaft impactor mill, grinder, pulveriser, mortar and pestle, blender, crusher, or manually to break the large agglomerates and reduce it to smaller particles.

At step 60, the method 50 includes subjecting the deagglomerated solid fraction to carbonization by heating said fraction under an inert atmosphere. It is preferred to carry out the carbonization process in two heating stages, preferably including a first isothermal heating stage and a second isothermal heating stage. In the first isothermal heating stage, the deagglomerated solid fraction is heated: to a temperature in the range of from about 400 to about 600° C., for example from about 450 to about 550° C., or from about 475 to 525° C.; for a duration of from about 0.5 to about 2 hours, for example from about 0.5 to about 1.5 hours, or from 0.75 to 1.25 hours. In a preferred embodiment, the first isothermal heating stage is carried out at a temperature of about 500° C. for about 1 hour. The first isothermal heating stage reduces the incidence in the heated fraction of crystalline phases attributable to K₂CO₃ and/or KHCO₃, as determined by X-ray diffraction.

The first isothermal heating stage is followed by a subsequent second isothermal heating stage in which the fraction is maintained: at a temperature in the range of from about 750 to about 1000° C., for example from about 800 to about 900° C. or about 825 to about 875° C.; for a duration of from about 0.5 to about 2 hours, for example from about 0.5 to about 1.5 hours, or from about 0.75 to about 1.25 hours. In a preferred embodiment, the second isothermal heating stage is carried out at a temperature of about 850° C. for about 1 hour.

In some embodiments, to transition between the first and second isothermal heating stages, the temperature of the heated fraction is increased at a rate of about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, or about 15° C./minute.

At step 62, the method 50 includes cooling and neutralizing the product of said carbonization. The product, obtained after heating, may be cooled to no more than 50, 45, 40, 37.5, 35, 32.5, 30, 27.5, 25, 22.5 or 20 C. to obtain a cooled activated carbon. Cooling to room temperature may be mentioned as being desirable. In some embodiments, the method further includes washing/rinsing the cooled activated carbon with an acid, such as HI, HBr, sulfuric acid, perchloric acid, acetic acid, citric acid, or preferably HCl, to obtain an acid-washed activated carbon; and/or, deacidifying the acid-washed product, generally by washing with water, preferably deionized water or alternatively with dilute ammonia and/or a dilute bicarbonate solution.

The activated carbon obtained in step 62 should have a pH in a range of from about 6.5 to about 7.5, for example from about 6.6 to about 7.4, from about 6.7 to about 7.3, from about 6.8 to about 7.2, from about 6.9 to about 7.1 or, preferably, about 7. It is not precluded that the activated carbon thus obtained be further dried at a temperature of from about 60 to about 100° C., for example from about 70 to about 90° C., for a period of from about 24 to about 48 hours to remove moisture.

In an embodiment, the activated carbon prepared by the method of present disclosure has a carbon content greater than about 80 wt. %, about 82 wt. %, about 84 wt. %, about 86 wt. %, about 88 wt. %, about 90 wt. %, about 91 wt. % or about 92 wt. %. In an embodiment, the carbon content in the activated carbon is about 92.3%. In an embodiment, which is not mutually exclusive of that noted above, the activated carbon prepared by the method of present disclosure has an oxygen content of at most 10 wt. %, for example at most 9 wt. %, at most 8 wt. % or at most 7 wt. %. In an embodiment, the activated carbon has an oxygen content of about 6.7%. In some embodiments, the carbon-to-oxygen (C/O) ratio by weight of the activated carbon is in the range of from about 10:1 to about 15:1, for example from about 11:1 to about 14:1, from about 12:1 to about 14:1, from about 13:1 to about 14:1, or about 13.7.

In an embodiment, the activated carbon as prepared by the method of present disclosure has a surface area, as determined by Brunauer-Emmett-Teller (BET) analysis of from about 2500 to about 3500 m²/g, for example from about 2800 to about 3200 m²/g, from about 2900 to about 3100 m²/g, from about 3000 to about 3050 m²/g, or about 3058 m²/g. The surface area of the activated carbon prepared by the method of this disclosure, involving two isothermal heating stages, was found to be much higher than that of activated carbon prepared by other methods, for which the surface area was found to be in the range of 650-1850 m²/g. Higher surface is indicative of greater the number of active sites available for adsorption.

In an embodiment, the activated carbon as prepared by the method of present disclosure has a median pore diameter of from about 4.0 to about 5.0 nm, for example from 4.0 to about 4.5 nm or from 4.0 to about 4.2 nm, as determined by Barrett-Joyner-Halenda (BJH) desorption analysis. In one embodiment, the activated carbon has a median pore diameter of about 4.1 nm, as determined by BJH desorption analysis. The pores in the activated carbon were found to have some heterogeneity in size: the activated carbon was both mesoporous and microporous.

In an embodiment, the activated carbon as prepared by the method of present disclosure has a pore volume of from about 0.2 to about 0.5 cm³/g, for example from about 0.2 to about 0.4 cm³/g, or from about 0.3 to about 0.4 cm³/g, as determined by Barrett-Joyner-Halenda (BJH) desorption analysis. In one specific embodiment, the pore volume is about 0.36 cm³/g, as determined by BJH desorption analysis.

In an embodiment, the total weight loss of the activated carbon, as determined by Thermogravimetric Analysis in accordance with ASTM E1131, is less than about 90 wt. %, preferably less than about 85 wt. %, when the activated carbon is heated from about 100 to about 1000° C. at a heating rate of about +10° C. per minute.

In an embodiment, the activated carbon of which the intensity ratio of the D peak to the G peak (I_{D}/I_{G}), as determined by Raman spectroscopic analysis, is from about 0.90 to about 1.00, preferably about 0.91. This ratio has been found to be higher than for activated carbon prepared by other methods, which have an I_{D}/I_{G} intensity ratio of about 0.75 to about 0.89. This ratio indicates a low intensity of crystalline peaks for the activated carbon prepared in accordance with the present disclosure. It is proposed that the multi-stage carbonization may serve to eliminate the unwanted crystalline phases—attributable to K₂CO₃ and/or KHCO₃—in that circumstance where a KOH-to-powdered biomass ratio by weight of from about 1.5:1 to about 2.5:1 is employed for activation of the carbonaceous precursor.

Referring back, the activated carbon of the present disclosure can be used as a carbon dioxide adsorbent. In particular, the activated carbon may selectively adsorb carbon dioxide from gas streams, such flue gas streams or gas streams from other combustion exhaust systems, such as auto, watercraft, or even aircraft exhaust, energy production exhausts, household furnaces and/or chimney exhaust.

A method for adsorbing carbon dioxide from a fluid including the flue gas is described. The method includes contacting the fluid source with the activated carbon. On contacting, the activated carbon can selectively adsorb CO₂, with greater selectivity compared to other gases, in particular methane and nitrogen.

In an embodiment, the activated carbon exhibits greater selectivity towards CO₂ over methane and nitrogen at a temperature of from about 0 to about 25° C., for instance at a temperature of from about 0 to about 15° C., from about 0 to about 5° C. or at about 0° C., under ambient pressure.

In an embodiment, the activated carbon of the present disclosure has a selectivity towards CO₂ about 5 to about 12 times higher than for methane (CH₄) and nitrogen (N₂). In an embodiment, the activated carbon has: a nitrogen (N₂) absorption capacity of at least 0.8 mmol/g, for example from about 0.8 to about 4 mmol/g or about 0.8 to about 3 mmol/g, as determined by volumetric analysis at a temperature of about 0° C. and an N₂ pressure of about 0.1 MPa; and, a CH₄ absorption capacity of at least 1.5 mmol/g, for example from about 1.5 to about 4 mmol/g or about 1.5 to about 3 mmol/g, as determined by volumetric analysis at a temperature of about 0° C. and an CH₄ pressure of about 0.1 MPa. However, the activated carbon has a carbon dioxide (CO₂) absorption capacity of at least about 10.0 mmol/g, for example of from about 10 to about 12 mmol/g, from about 11 to about 12 mmol/g, or about 11.3 mmol/g, as determined by volumetric analysis at a temperature of about 0° C. and an CO₂ pressure of 0.1 MPa.

### EXAMPLES

The following examples demonstrate an activated carbon as described herein. The examples are provided solely for illustration and are not to be construed as limitations of the present disclosure, as many variations thereof are possible without departing from the spirit and scope of the present disclosure.

### Example 1: Materials and Methods

Balanites aegyptiaca (desert date) seed shells from Khartoum, Sudan, considered to be an agricultural waste, served as a biomass source. White pellets of potassium hydroxide (KOH) with a pH of about 13.5 were used as an activation agent and hydrochloric acid (HCl) 37% was used to prepare 1 molar (M) solution in de-ionized (DI) water to clear any residual ash. The gases used in the present disclosure include nitrogen (N₂) (99.999%), oxygen (O₂) (99.99%), methane (CH₄) (99.999%), and air (99.999%). The process commenced with grinding the desert date seeds for 5 minutes using a heavy-duty grinder (HC-G-100N) which yielded a 50 mesh to 300 mesh granularity. The obtained biomass powder was subsequently mixed with KOH, and two mixtures having KOH-to-biomass ratios of 1:1 (composition A) and 2:1 (composition B) by mass were produced. Homogeneous solutions were created by dissolving 15 grams (g) of composition A in 100 ml of deionized (DI) water and 20 g of composition B in 150 ml of DI water. Subsequently, the solutions underwent rigorous stirring for two hours. The blend was then dried at 80° C. for 72 hours and manually ground to break down the large agglomerates. Further, carbonization of the blend was conducted at an elevated temperature in a tubular furnace (OFT-1200X) under a 200 cubic centimeter per minute (cm³/min) flow of argon gas. In order to evaluate the effect of temperature on the characteristics of activated carbon (AC), two distinct heating profiles were used to carbonize the blend. Profile 1 involved isothermally heating the blend at 850° C. for 2 hours; profile 2 involved isothermally heating the blend at 500° C. for 1 hour followed by a further isothermal heating at 850° C. for an additional hour. To reach the stated isothermal heating temperatures, a heating rate of 10 degree Celsius per minute (C/min) was employed in both profiles. Once the heating cycle was completed, the furnace was allowed to cool down under ambient conditions. The resulting activated carbon (AC) was rinsed with 1 molar (M) HCl solution to eliminate any residual ash and subsequently rinsed with DI water until the elute became neutral. Finally, the AC was filtered out and dried for 48 hours at 80° C.

Following the given protocols, the end products were four distinct samples of ACs based on two different KOH-to-biomass ratios and heating profiles. These samples were labeled as A(850), A(500-850), B(850), and B(500-850). The B(500-850) sample is that prepared in accordance with the present disclosure.

The surface area and porosity of the ACs were measured using the ASAP2020 instrument (Micromeritics). The analysis was based on N₂ adsorption/desorption isotherms obtained at about 77 K. The surface area was determined using the Brunauer-Emmett-Teller (BET) technique while the pore size was calculated through the desorption branch of the isotherm following the Barrett-Joyner-Halenda (BJH) method. Before testing, all samples underwent degassing for 8 hours at 200° C.

The crystallinity of the ACs was examined through X-ray diffraction (XRD) using a Miniflex II diffractometer (Rigaku). For XRD examination, Cu Kα radiation (λ=1.5405 Å) was employed and was generated using a voltage and current of 30 Kilovolt (kV) and 15 Megaampere (mA), respectively. The step size of 0.02° and the data acquisition rate of 2 degree per minute (°/min) were maintained.

The morphology of the ACs was investigated using the Lyra3 field emission scanning electron microscope (FESEM) (Tescan). The AC samples were attached to the SEM stub via copper tape and a 5 nm thick layer of gold was sputter-coated onto the samples to improve the micrograph contrast.

The elemental composition of the activated carbons (ACs) was determined using energy-dispersive X-ray spectroscopy (EDS) operating in conjunction with FESEM. The thermal stability of the ACs was assessed via thermogravimetric analysis (TGA) using the STA449F3 Jupiter thermal analyzer (Netzsch) under a continuous air flow rate of 20 cm³/min. The heating rate was maintained at 10° C./min.

To gain further structural insights about the ACs, Raman analysis was performed using the DXR3 Raman microscope (Thermo Fisher Scientific). The analysis contained 10 scans obtained using a laser wavelength of 455 nm, a spot size of 1.8 microns, and an exposure time of 20 s.

The adsorption capacity and selectivity of the ACs were assessed at 0° C., 15° C., and 25° C. using the QuadraSorb (Evo) version 6 automatic surface area and pore size analyzer. Approximately 150 mg of AC sample was first degassed for 10 hours at 200° C. in a 9 mm bulb-type glass tube to remove any residual moisture. The pressure was varied from 0 to 760-millimeter mercury (mmHg) while recording the adsorbed volume of a gas. CO₂, CH₄, and N₂ were used as analyte gases.

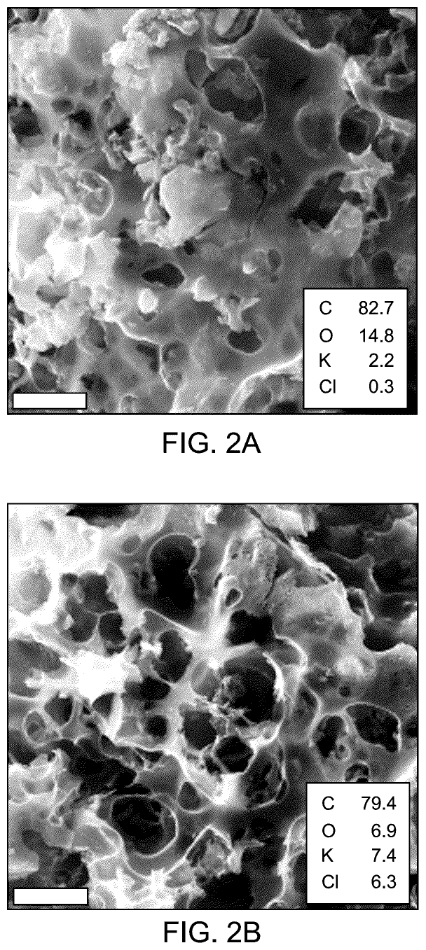

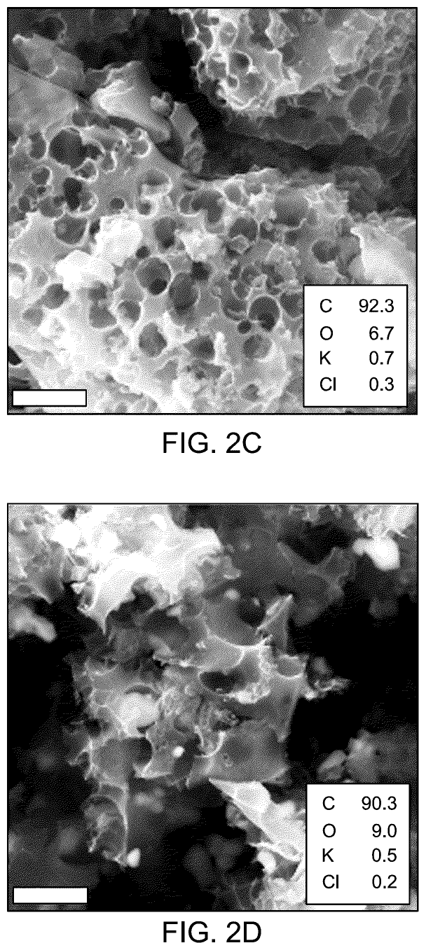

The morphological characteristics of the ACs as revealed via FESEM are presented in FIGS. 2A-2D. For A(500-850), the porosity and surface development appear to be restricted as the pore shape and size were found to be more random. In the case of A(850), the porosity development improved, however, the pore structure and morphology remain distorted. Upon doubling the KOH content and carbonizing in a stage-wise manner for the sample B(500-850), the pores exhibited more uniform shape and size without any noticeable structural collapse. In some embodiments, heating B(500-850) directly to 850° C. resulted in structural collapse of the AC, leading to a loss in the porous framework, which is a prerequisite for efficient adsorption. These observations are in line with several previous research where a high KOH-to-biomass ratio was found to be necessary for fine and mesoporous structural development in the AC for increased adsorption capacity [See: S. Deng et al., “Activated carbons prepared from peanut shell and sunflower seed shell for high CO₂ adsorption”, Adsorption, Vol. 21, No. 1-2:125-133 (2015); M. E. Casco et al., “Effect of the porous structure in carbon materials for CO₂ capture at atmospheric and high-pressure”, Carbon N Y, Vol. 67:230-235 (2014); and, C. Liu et al., “N-containing activated carbons for CO₂ capture”, Int. J. Smart Nano. Mater., Vol. 4, No. 1:55-61 (2013), the disclosures of which documents are incorporated herein in their entirety.] Moreover, an optimal temperature profile for carbonization with an intermediate isothermal stage seems critical for pore refinement and structural integrity in the AC. In general, adding an isothermal step near the pyrolytic temperature during carbonization minimizes pore restrictions in AC, which promotes the formation of interconnected mesoporous networks in AC. [See: A. Pastor, et al. “Preparation of activated carbon cloths from viscous rayon. Part I. Carbonization procedures”, Carbon N Y, Vol. 37:1275-1283 (1999); and, S. H. Yoon, et al. “Multi-staged carbonization of aramid fibers”, Proceedings of the 22nd Biennial Conference on Carbon, Extended Abstract and Program, San Diego, CA, Page 218 (1995), the disclosures of which documents are incorporated herein in their entirety.] The elemental composition shown in the insets of FIGS. 2A-2D reveals higher C (>90%) and lower K (<1%) content in the samples prepared with a KOH-to-biomass ratio of 2:1 as compared to the samples wherein the ratio was maintained at 1:1. Hence, it may be corroborated that the use of higher ratio by weight of KOH to powdered precursor may result in the redox reaction between the K compounds and C and the subsequent expansion of the C framework due to the intercalation of metallic K. As a consequence, there may be a yield of char within a 3D porous framework which is preserved upon adding an isothermal heating stage during carbonization [See: J. Wang, et al., “Fungi-based porous carbons for CO₂ adsorption and separation”, J. Mater. Chem., Vol. 22, No. 28:13911-13913 (2012), the disclosure of which is herein incorporated by reference in its entirety.] Furthermore, the highest C/O ratio was observed for sample B(500-850), which reinforces the significance of both the higher KOH ratio by weight and the stage-wise carbonization in minimizing the concentration of oxygen-based functional groups within the AC lattice which would otherwise favor the adsorption of polar moieties, such as CO₂ [See: R. Chen et al., “Fundamental understanding of oxygen content in activated carbon on acetone adsorption desorption”, Appl. Surf. Sci., Vol. 508 (2020), the disclosure of which is herein incorporated by reference in its entirety.]

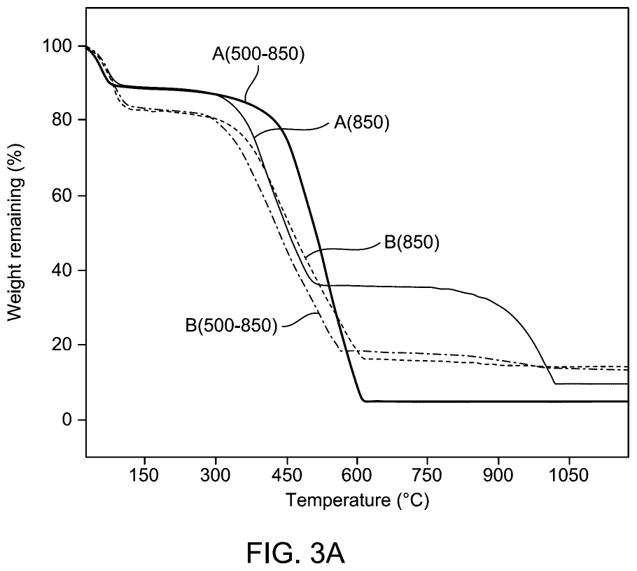

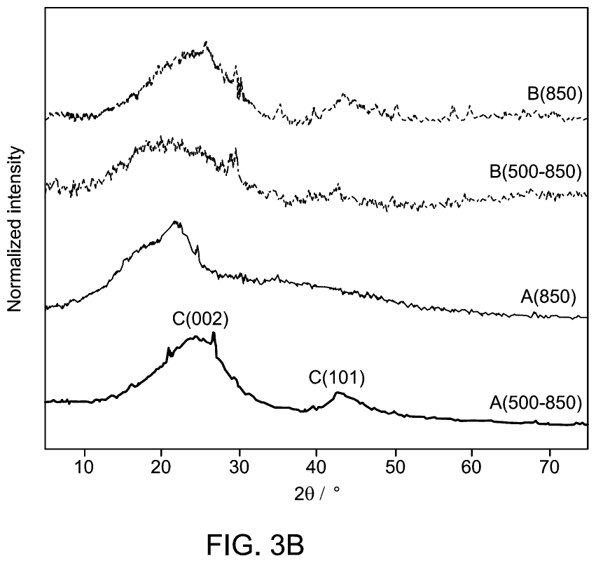

The thermal stability of ACs, as determined by thermal gravimetric analysis (TGA), is shown in FIG. 3A. It is observed that all samples underwent initial weight loss until 100° C., which may be attributed to the loss of physiosorbed water from the ACs. The loss was noticeably higher for the samples prepared with a KOH-to-biomass ratio of 2:1, plausibly due to the higher porosity and high hydrophilicity of the activated carbon. Weight loss in all ACs was also observed in the temperature range of from 300° C. to 600° C., which may be attributed to the combined evolution of CO₂ and CO owing to the decomposition of various surface oxygen groups. [See: L. Figueiredo, et al., “Modification of the surface chemistry of activated carbons”, Carbon N. Y., Vol. 37:1379-1389 (1999), the disclosure of which is herein incorporated by reference in its entirety.] The most significant weight loss in the same temperature range was observed for A(500-850), which shows a more significant formation of the surface oxygen groups in the AC when stage-wise heating and a KOH-to-biomass ratio of 1:1 was used. An interesting observation is the presence of a sharp shoulder for sample A(850) in the temperature range of from 500° C. to 1000° C. which may be attributed to the increased presence of carbonyl and quinone surface groups that are known to exist in the AC and decompose at higher temperatures to yield CO. [See: U. Zielke, et al., “Surface-oxidized carbon fibers: I, surface structure and chemistry”, Carbon N.Y., Vol. 34, No. 8:983-998 (1996), the disclosure of which is incorporated herein by reference in its entirety.] For the ACs where the KOH-to-biomass ratio of 2:1 was used, the thermal decomposition profile was found to be almost identical with a diffuse shoulder in the temperature range of from 500° C. to 1000° C., which may be attributed to the presence of some stable oxygen groups in a small concentration. The lower total weight loss was observed in the ACs prepared with a KOH-to-biomass ratio by weight of 2:1 (~85%) as compared to the ACs where the ratio by weight was maintained at 1:1 (>90%).

The XRD analysis of the ACs shown in FIG. 3B confirms the existence of two amorphous C peaks, (002) and (101), in all samples: this confirms the retention of the C lattice under all processing conditions. For the samples prepared with a KOH-to-biomass ratio by weight of 2:1, some diffuse crystalline peaks are evident, especially for B(850). The diffuse peaks may be attributed to the carbonates and bicarbonates of potassium, which are likely to precipitate due to the higher concentration of KOH. Such crystalline phases are highly undesirable as they may reduce the net porosity and surface area of the AC, thus negatively affecting its adsorption ability. A sharp decline in the intensity of the crystalline peaks was observed for B(500-850), which emphasizes the importance of multi-stage carbonization to eliminate the unwanted crystalline phases when higher KOH-to-biomass ratios are used.

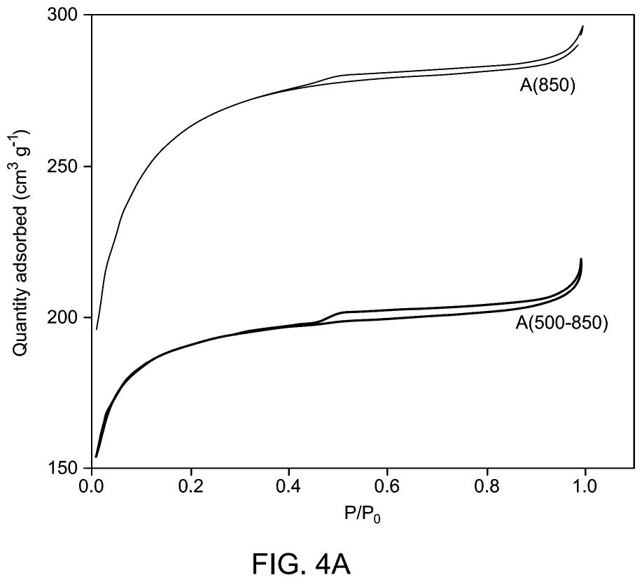

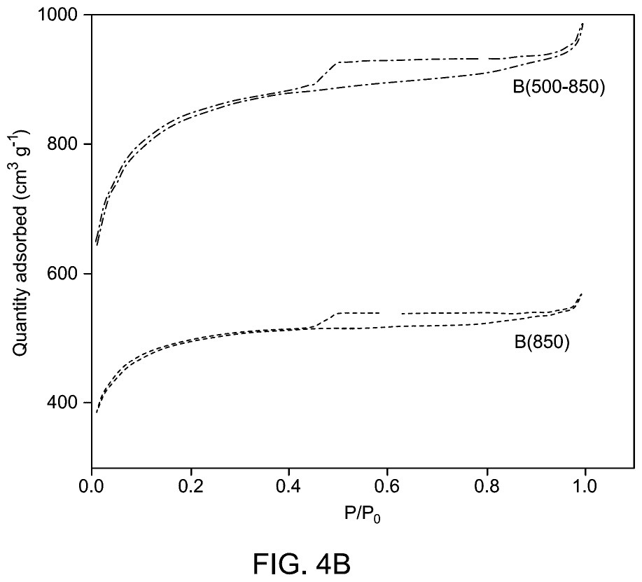

The textural characteristics of type A and B activated carbon are presented in FIG. 4A and FIG. 4B, respectively. All ACs depict type IV adsorption/desorption isotherms, confirming the mesoporous nature. [See: J. C. P. Broekhoff, “Mesopore determination from nitrogen sorption isotherms: fundamentals, scope, limitations” Stud. Surf. Sci. Catal., Vol. 3:663-684 (1979), the disclosure of which is herein incorporated by reference in its entirety.] The adsorption capacity of type B ACs was found to be more than double than that of type A samples, which confirms the importance of a high KOH-to-biomass ratio by weight for maximizing the porosity and surface area of AC. Moreover, employing multistage isothermal heating doubled the adsorption capacity, proving that an intermediate isothermal step is equally important for maximizing the surface area and hence the adsorption capacity of AC.

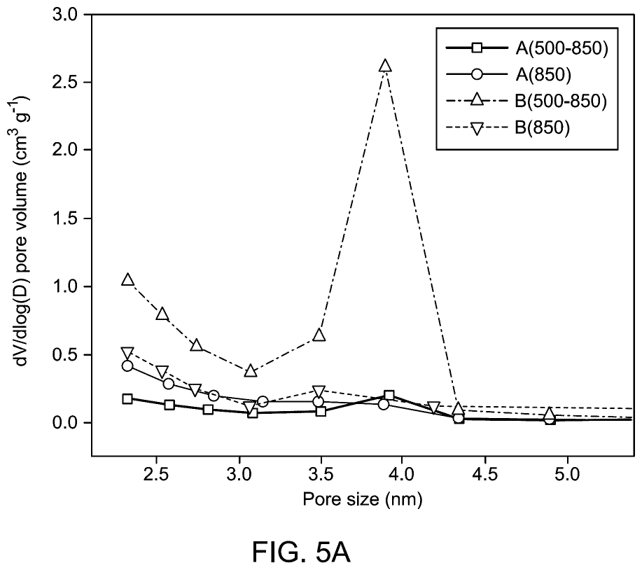

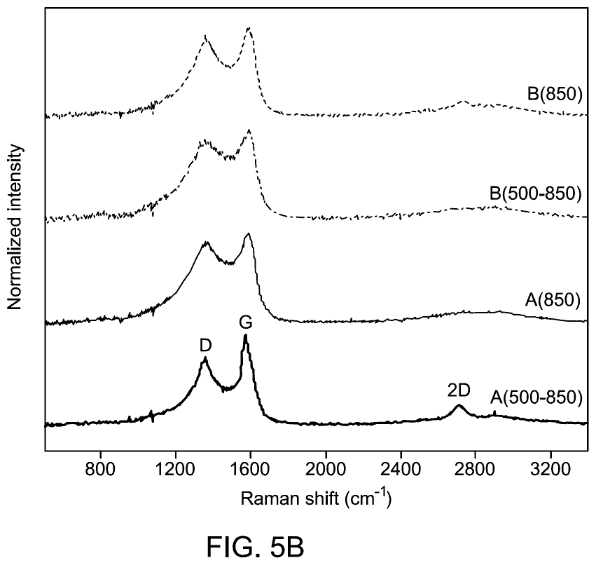

The pore size distribution for the ACs determined through BJH desorption data is shown in FIG. 5A. The distribution peak for all ACs occurred in the size range of 3 to 4.5 nm, but the peak intensity is nearly 5 times greater for the B(500-850) sample: this confirms the importance of high KOH-to-biomass ratio and multi-stage thermal activation in maximizing mesoporosity as well as achieving pore-size uniformity. The aforementioned observation is in accordance with the BET isotherms, wherein the N₂ adsorption capacity was evidently higher for the B(500-850) sample due to the substantial proportion of mesoporous volume.

The Raman analysis is depicted in FIG. 5B, which demonstrated noticeable differences in the peak intensities corresponding to the D and G bands of the activated carbons (Acs) dependent upon the KOH: biomass ratio by weight and isothermal heating regime employed. The intensity ratio of the bands (I_{D}/I_{G}) was found to be 0.75, 0.89, 0.91, and 0.88 for samples A(500-850), A(850), B(500-850), and B(850), respectively. A high I_{D}/I_{G} ratio is considered to represent a greater degree of amorphization (or a lower degree of graphitization) [See: Jae-Seung Roh, “Structural study of the activated carbon fiber using laser raman spectroscopy” Carbon Letters, Vol. 9:127-130 (2008), the disclosure of which is incorporated herein by reference in its entirety.] It may thus be inferred that a lower KOH-to-biomass ratio and multi-step heating (Sample A(500-850)) provides for the retention of some degree of graphitization in the activated carbon (AC), which limits its surface area and adsorption capacity. An increased I_{D}/I_{G} ratio was observed for the remaining three ACs which indicates a high degree of amorphization. However, despite similar I_{D}/I_{G} ratios in the three ACs, a drastic difference in the adsorption capacity manifests a significant difference in the microstructure.

The yield and textural properties of the ACs are listed in Table 1. The type A activated carbon prepared with a KOH-to-biomass weight ratio of 1:1 showed higher yield under single as well as multi-stage heating, indicating that the KOH proportion is sufficient for effective carbon activation without any significant structural damage. In contrast, the type B activated carbon, where the KOH-to-biomass weight ratio was maintained at 2:1, showed reduced yields of 42.34% (multi-stage heating) and 35.76% (single-stage heating) respectively, suggesting that an increased KOH concentration may cause greater matrix erosion. The higher KOH concentration, however, may facilitate deeper pore development which is reflected by the notably large surface area and porosity, making it potentially effective for producing ACs with a higher adsorption capacity. As far as the activation profile is concerned, heating the sample directly to the activation temperature may lead to rapid devolatilization while deteriorating the pore structure. The rapid increase in temperature may hinder the gradual gas evolution which is crucial for developing a well-defined pore structure. Furthermore, the yield may be reduced due to the rapid escape of volatiles from the biomass matrix. In some embodiments, multi-stage heating enables controlled pyrolysis and a steady activation process. The initial isothermal heating stage at 500° C. may facilitate the slow release of moisture and volatile matter, preparing the char for a controlled activation, while the subsequent isothermal heating at 850° C. leads to pore development and refinement. Moreover, by separating the devolatilization and activation stages, a potentially higher yield of AC with a refined pore structure may be obtained.

TABLE 1

| | Production | BET Surface | BJH pore | Pore |
|---|---|---|---|---|
| Activated | yield | area | size | Volume |
| carbon type | (%) | (m²/g) | (nm) | (cm³/g) |
| A (500-850) | 49.84 | 693 | 4.93 | 0.06 |
| A (850) | 46.46 | 954 | 3.79 | 0.09 |
| B (500-850) | 42.34 | 3058 | 4.1 | 0.36 |
| B (850) | 35.76 | 1802 | 4.44 | 0.17 |

For the KOH-to-biomass ratio of 1:1, the surface area and pore volume were found to be higher in the case of single-stage carbonization as compared to multi-stage carbonization. An opposite trend was observed when the KOH-to-biomass ratio of 2:1 was used. The surface area and the pore volume increased to about 3058 m²/g and 0.36 cm³/g, respectively, when the KOH-to-biomass ratio of 2:1 and multi-stage carbonization were employed. The aforementioned values are significantly higher than most of the reported activated carbons (ACs) in the literature, especially those derived from biomass [See: A. Ali Abd, et al., “A review on application of activated carbons for carbon dioxide capture: present performance, preparation, and surface modification for further improvement”, Environ. Sci. Pollut. Res. Int. 28(32):43329-43364 (2021), the disclosure of which is incorporated herein by reference in its entirety.] Further, the average pore size reduced to 4.1 nm, which manifests the role of optimal synthesis condition in pore refinement. It is to be noted that the average pore size was found to be only 3.79 nm for the KOH-to-biomass weight ratio of 1:1 under single-stage carbonization, but the corresponding pore volume is an order of magnitude lower which shows limited lattice expansion and pore refinement under the processing conditions.

In general, depending on the biomass type, the microporosity and surface area of the AC may be enhanced by increasing the KOH-to-biomass ratio and optimizing the activation temperature [See: M. E. Casco et al., “Effect of the porous structure in carbon materials for CO₂ capture at atmospheric and high-pressure”, Carbon N. Y., Vol. 67:230-235 (2014); X.-L. Zhu et al., “Activated carbon produced from paulownia sawdust for high-performance CO₂ sorbents”, Chinese Chemical Letters, Vol. 25, No. 6:929-932 (2014). S. Deng et al. “Superior CO₂ adsorption on pine nut shell-derived activated carbons and the effective micropores at different temperatures” Chemical Engineering Journal, Vol. 253:46-54 (2014), and, H. Wei et al. “Granular bamboo-derived activated carbon for high CO₂ adsorption: the dominant role of narrow micropores”, Chem. Sus. Chem, Vol. 5, No. 12:2354-2360 (2012), the disclosures of which documents are herein incorporated by reference in their entirety.] Even at a low KOH-to-biomass ratio of 0.5, an activation temperature of about 750° C. resulted in an improvement in the textural characteristics and hence the adsorption capacity of AC when coconut shells were used as a biomass source. [See: J. Bai et al. “Fabrication of coconut shell-derived porous carbons for CO₂ adsorption application”, Front. Chem. Sci. Eng., Vol. 17, No. 8:1122-1130 (2023), the disclosure of which is incorporated herein by reference in its entirety.] The present disclosure confirms the importance of a higher KOH-to-biomass ratio and details an improvement in the textural properties upon adding an isothermal step during carbonization. It may be inferred that holding the KOH and biomass mix close to the pyrolysis temperature for a suitable duration enhances K intercalation, thus promoting lattice expansion and porosity development in the carbon (C).

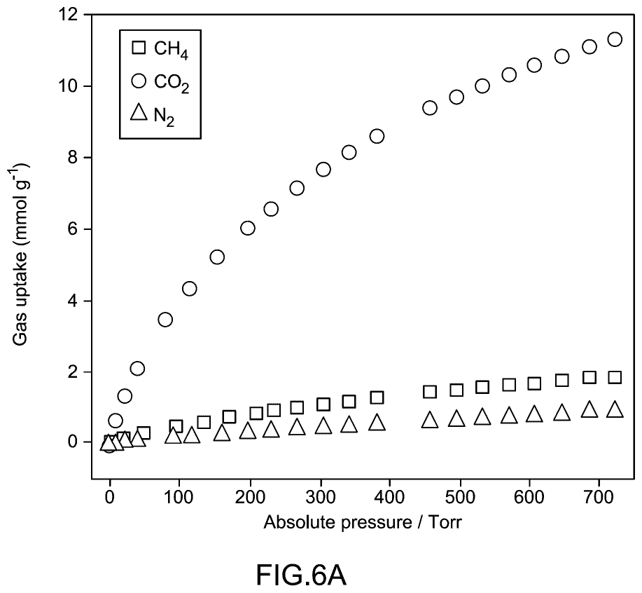

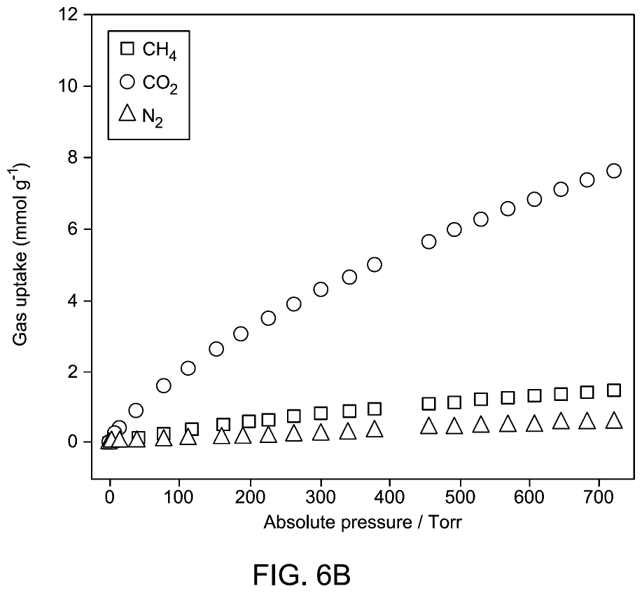

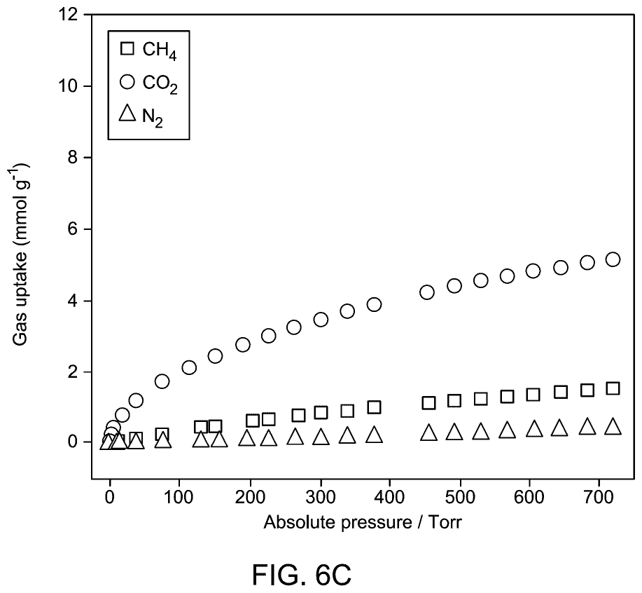

Among the four types of ACs synthesized in the present disclosure, B(500-850) was evaluated for CO₂ uptake capacity and selectivity towards different gases, and the results are presented in FIG. 6. Under ambient pressure, the CO₂ uptake capacity was 11.3 mmol/g, 7.6 mmol/g, and 5.2 mmol/g at 0° C., 15° C., and 25° C., respectively. Further, compared to CH₄ and N₂, the uptake capacity for CO₂ was found to be nearly 5 times and 12 times higher, respectively, at all temperatures, illustrating clear selectivity of the activated carbon (AC) towards CO₂. Based on the ratio of the maximum adsorption capacities, the selectivity for CO₂ over CH₄ and N₂ at 0° C. was found to be 6.1 and 12.7, respectively. The heat of adsorption for CO₂, CH₄, and N₂, calculated using the Clausius-Clapeyron equation, was found to be 38.6 kilojoules per mole (KJ/mol), 9.1 KJ/mol, and 23.7 KJ/mol, respectively.

The CO₂ uptake capacity under ambient conditions (25° C.; 1 atm) for biomass-derived ACs with a surface area under 3000 m²/g has been reported to be in the range of 1.3 mmol/g to 5.6 mmol/g, while at 0° C., a CO₂ uptake capacity of up to 8 mmol/g has been reported [See: A. Ali Abd et al., “A review on application of activated carbons for carbon dioxide capture: present performance, preparation, and surface modification for further improvement”, Environ. Sci. Pollut. Res. Int. 28(32):43329-43364 (2021), the disclosure of which is incorporated herein by reference in its entirety.]. Thus, the AC synthesized in the present disclosure, using a KOH-to-biomass ratio of 2:1 and two-step isothermal carbonization offers a high surface with favorable textural properties for high CO₂ uptake. A high selectivity towards CO₂ makes the AC described herein an ideal adsorbent for environmental remediation. As can be seen from Table 1, the optimal set of synthesis parameters provided remarkably high surface area and pore volume compared to the other three ACs. It may be noted that the AC possesses higher microporosity, which may favor the selective adsorption of CO₂.

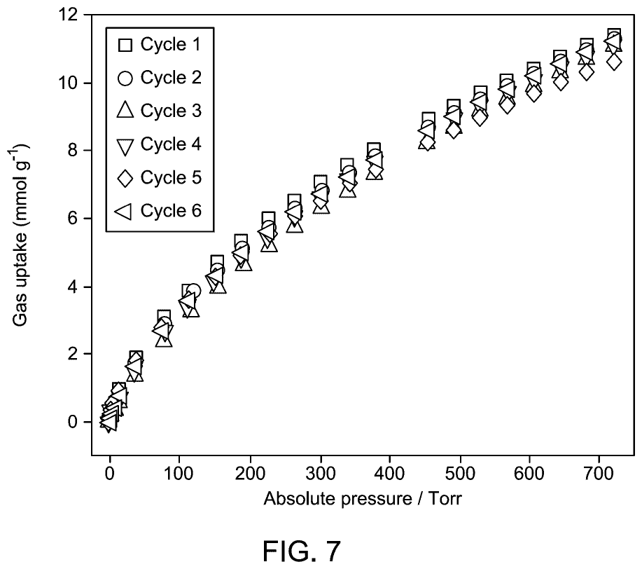

In order to determine the repeatability of CO₂ uptake for the B (500-850) activated carbon AC, the cyclic tests were performed at 0° C. for the same AC sample and the results are depicted in FIG. 7. As can be seen from FIG. 7, the CO₂ uptake remained consistent at varying pressures after six cycles, without any noticeable drop in the adsorption capacity: this corroborates the feasibility of the AC for commercial use. In general, the selective adsorption of CO₂ is primarily governed by the pore size and shape of the AC and is based on the kinetic diameter of the CO₂ molecule: microporosity is highly desirable for the entrapment of CO₂ molecules within the pore walls of the AC. [See: Z. Chen et al., “Activated carbons and amine-modified materials for carbon dioxide capture—A review”, Front. Environ. Sci. Eng., Vol. 7, No. 3:326-340 (2013), the disclosure of which is incorporated herein by reference in its entirety.] The presence of some functional groups on the AC's surface, such as —OH, may further enhance the chemical interaction with the CO₂ molecules leading to the enhanced adsorption. [See: L. Hong et al., “Highly selective CO₂ uptake in novel fishnet-like polybenzoxazine-based porous carbon”, Energy and Fuels, Vol. 33, No. 11:11454-11464 (2019), the disclosure of which is incorporated herein by reference in its entirety.] This phenomenon is further exaggerated due to the polar nature of the CO₂ molecules as opposed to non-polar CH₄ and N₂ molecules. [See: J. Singh et al., “CO₂ capture by modified porous carbon adsorbents: Effect of various activating agents”, J. Taiwan Inst. Chem. Eng., Vol. 102:438-447 (2019); and, H. Sugiyama et al. “Selective and enhanced CO₂ adsorption on fluorinated activated carbon fibers”, Chem. Phys. Lett., Vol. 758 (2020), the disclosures of which documents are herein incorporated by reference in their entirety.] Nevertheless, an optimal synthesis route, i.e., high KOH-to-biomass ratio, and two-step carbonization, seems paramount for converting the biomass into the AC with optimal textural and chemical properties for improved CO₂ adsorption with enhanced selectivity over other gases. From a practical perspective, such ACs are highly desirable to capture CO₂ efficiently and selectively from a mixture of gases, which is generally the case with most industrial emissions, such as the flue gas.

Several studies have reported the synthesis of AC using various biomass sources while employing KOH as a chemical activator. Moreover, the effectiveness of the ACs as CO₂ adsorbent was evaluated. These investigations have focused on improving the CO₂ adsorption capacity of AC while understanding the governing mechanisms of CO₂ capture. A summary of some important literature findings is given in Table 2 along with the results obtained in the present work. As evident, the CO₂ uptake capacity of the AC synthesized in the present disclosure is significantly higher at 0° C. when compared with similar ACs reported previously. Also, at 15° C. and 25° C., the uptake capacities are close to the values reported in the literature that were recorded at 0° C. for similar types of ACs. This comparison is quite encouraging and proves the significance of a high KOH-to-biomass ratio and an optimal carbonization profile to enhance the surface area and pore structure of AC for maximum CO₂ adsorption.

TABLE 2
CO₂ adsorption capacity of various biomass-derived ACs

| | Carboni- | | | |
|---|---|---|---|---|
| | zation | BET | Adsorption | |
| | temper- | surface | capacity @ | |
| | ature | area | 0° C. | Refer- |
| Biomass source | (° C.) | (m²/g) | (mmol/g) | ence |
| Fir bark | 700 | 1242 | 6.1 | 1* |
| Paulownia sawdust | 800 | 1555 | 4.17 | 2* |
| Soya beans | 400 | 1193 | 4.24 | 3* |
| Bamboo | 800 | 2000 | 7 | 4* |
| Wheat | 800 | 2192 | 5.7 | 5* |
| Black locust | 740 | 2511 | 5.86 | 6* |
| Celtuce leaves | 800 | 3004 | 6.04 | 7* |
| Eucalyptus sawdust | 800 | 2850 | 5.2 | 8* |
| Sunflower seed | 500 | 1790 | 7.1 | 9* |
| Cotton stalk | 700 | 2695 | 6.9 | 10* |
| Sawdust | 700 | 1643 | 8 | 11* |
| Seed shells of | 500-850 | 3058 | 11.3 | Present |
| Balanites | (Multi-step | | 7.66 (@ 15° C.) | disclo- |
| aegyptiaca | isothermal | | 5.20 (@ 25° C.) | sure |
| | heating) | | | |

1* L. Luo, T. Chen, Z. Li, Z. Zhang, W. Zhao, and M. Fan, “Heteroatom self-doped activated biocarbon from fir bark and their excellent performance for carbon dioxide adsorption”, the disclosure of which is incorporated herein in its entirety.
2* X.-L. Zhu, P.-Y. Wang, C. Peng, J. Yang, and X.-B. Yan, “Activated carbon produced from paulownia sawdust for high-performance CO₂ sorbents”, the disclosure of which is incorporated herein in its entirety.
3* C. Liu, W. Xing, J. Zhou, and S. P. Zhuo, “N-containing activated carbons for CO₂ capture” the disclosure of which is incorporated herein in its entirety.
4* H. Wei and other researchers., “Granular bamboo-derived activated carbon for high CO₂ adsorption: The dominant role of narrow micropores”, the disclosure of which is incorporated herein in its entirety.
5* S. M. Hong, E. Jang, A. D. Dysart, V. G. Pol, and K. B. Lee, “CO₂ capture in the sustainable wheat-derived activated microporous carbon compartments”, the disclosure of which is incorporated herein in its entirety.
6* C. Zhang, W. Song, Q. Ma, L. Xie, X. Zhang, and H. Guo, “Enhancement of co₂ capture on biomass-based carbon from black locust by KOH activation and ammonia modification”, the disclosure of which is incorporated herein in its entirety.
7* R. Wang, P. Wang, X. Yan, J. Lang, C. Peng, and Q. Xue, “Promising porous carbon derived from celtuce leaves with outstanding supercapacitance and CO₂ capture performance”, the disclosure of which is incorporated herein in its entirety.
8* M. Sevilla and A. B. Fuertes, “Sustainable porous carbons with a superior performance for CO₂ capture”, the disclosure of which is incorporated herein in its entirety.
9* S. Deng and other researchers., “Activated carbons prepared from peanut shell and sunflower seed shell for high CO₂ adsorption”, the disclosure of which is incorporated herein in its entirety.
10* P. Pramanik, H. Patel, S. Charola, S. Neogi, and S. Maiti, “High surface area porous carbon from cotton stalk agro-residue for CO₂ adsorption and study of techno-economic viability of commercial production”, the disclosure of which is incorporated herein in its entirety.
11* X.-L. Zhu, P.-Y. Wang, C. Peng, J. Yang, and X.-B. Yan, “Activated carbon produced from paulownia sawdust for high-performance CO₂ sorbents”, the disclosure of which is incorporated herein in its entirety.

The aspects of the present disclosure provide a method of production of an activated carbon having utility for carbon dioxide capture. In particular, the synthesis and performance of activated carbon made from Balanites aegyptiaca (Desert date) seed shells is described herein, which is an abundant agricultural waste in the Middle East and Africa. The synthesis route involved pretreating the biomass with KOH and heating the biomass under a suitable temperature profile. Further, a KOH-to-biomass ratio and multi-stage isothermal carbonization yielded activated carbon with a surface area of about 3000 m²/g and an average pore size of about 4.1 nm. At 0° C., a synthesized activated carbon in accordance with the disclosure exhibited a CO₂ uptake of 11.3 mmol/g which surpassed the uptake capacity of activated carbons known in the art. The selectivity of this synthesized activated carbon towards CO₂ was found to be significantly higher compared to other gases. Thus, the present disclosure demonstrates an efficient conversion of agricultural waste to activated carbon for capturing CO₂ and other environmental contaminants.

Numerous modifications and variations of the present disclosure are possible in light of the above teachings. It is therefore to be understood that within the scope of the appended claims, the invention may be practiced otherwise than as specifically described herein.

1. A method of preparing activated carbon from seed shells of Balanites aegyptiaca, said method comprising:
comminuting the seed shells to form a powder having a particle size of from about 50 to about 300 mesh;
admixing the powder with solid state KOH at a ratio by weight of KOH: powder of from about 1.5:1 to about 2.5:1;
forming a slurry of the obtained mixture in water under stirring for a duration of from about 1 to about 5 hours;
drying the obtained slurry and deagglomerating the residual solid fraction thereof;
subjecting the deagglomerated solid fraction to carbonization by heating said fraction under an inert atmosphere, wherein said heating comprises:
a first isothermal heating stage in which the fraction is maintained at a temperature in the range of from about 400 to about 600° C. for a duration of from about 0.5 to about 2 hours; and,
a subsequent second isothermal heating stage in which the fraction is maintained at a temperature in the range of from about 750 to about 1000° C. for a duration of from 0.5 to 2 hours; and,
cooling and neutralizing the product of the carbonization.

2. The method according to claim 1, wherein the ratio by weight of KOH: powder is from about 1.8:1 to about 2.2:1.

3. The method according to claim 1, wherein the ratio by weight of KOH: powder is about 2:1.

4. The method according to claim 1, wherein the molarity of KOH in the slurry is from about 1 to about 3 moles per liter.

5. The method according to claim 1, wherein the molarity of KOH in the slurry is from about 1 to about 2 moles per liter.

6. The method according to claim 1, wherein the first isothermal heating stage reduces the incidence in the heated fraction of crystalline phases attributable to K₂CO₃ and/or KHCO₃, as determined by X-ray diffraction.

7. The method according to claim 1, wherein in the first isothermal heating stage, the heated fraction is maintained at a temperature in the range of from about 450 to about 550° C. for a duration of from about 0.5 to about 1.5 hours.

8. The method according to claim 1, wherein in the second isothermal heating stage, the heated fraction is maintained at a temperature in the range of from about 800 to about 900° C. for a duration of from about 0.5 to about 1.5 hours.

9. The method according to claim 1, wherein between the first and second isothermal heating stages, the temperature of the heated fraction is increased at a rate of from about 5 to about 15° C. per minute.

10. The method according to claim 1, wherein the product of carbonization is neutralized by rinsing the product with an aqueous HCl solution and subsequently with deionized water.

11. An activated carbon obtained by the method as defined in claim 1, wherein the activated carbon has:
a surface area of from about 2500 to about 3500 m²/g as determined by Brunauer-Emmett-Teller (BET) analysis;
a median pore diameter of from about 4.0 to about 5.0 nm as determined by Barrett-Joyner-Halenda (BJH) desorption analysis; and,
a pore volume of from about 0.2 to about 0.5 cm³/g as determined by Barrett-Joyner-Halenda (BJH) desorption analysis.

12. The activated carbon according to claim 11, wherein the activated carbon has:
a surface area of from about 2800 to about 3200 m²/g as determined by Brunauer-Emmett-Teller (BET) analysis;
a median pore diameter of from about 4.0 to about 4.5 nm as determined by Barrett-Joyner-Halenda (BJH) desorption analysis; and,
a pore volume of from about 0.3 to about 0.4 cm³/g as determined by Barrett-Joyner-Halenda (BJH) desorption analysis.

13. The activated carbon according to claim 11, wherein the total weight loss of the activated carbon, as determined by Thermogravimetric Analysis in accordance with ASTM E1131, is less than about 90 wt. % when the activated carbon is heated from about 100 to about 1000° C. at a heating rate of about +10° C. per minute.

14. The activated carbon according to claim 11, wherein the total weight loss of the activated carbon, as determined by Thermogravimetric Analysis in accordance with ASTM E1131, is less than about 85 wt. % when the activated carbon is heated from about 100 to about 750° C. at a heating rate of about +10° C. per minute.

15. The activated carbon according to claim 11 of which the intensity ratio of the D peak to the G peak (I_{D}/I_{G}), as determined by Raman spectroscopic analysis, is from about 0.90 to about 1.00.

16. The activated carbon according to claim 11 having a nitrogen (N₂) absorption capacity of at least about 0.8 mmol/g as determined by volumetric analysis at a temperature of about 0° C. and an N₂ pressure of 0.1 MPa.

17. The activated carbon according to claim 11 having a methane (CH₄) absorption capacity of at least about 1.5 mmol/g as determined by volumetric analysis at a temperature of about 0° C. and an CH₄ pressure of 0.1 MPa.

18. The activated carbon according to claim 11 having a carbon dioxide (CO₂) absorption capacity of at least about 10.0 mmol/g as determined by volumetric analysis at a temperature of about 0° C. and an CO₂ pressure of 0.1 MPa.

19. A method for adsorbing carbon dioxide from a fluid comprising that compound, the method comprising contacting the fluid source with the activated carbon as defined in claim 11.

20. The method according to claim 19, wherein the fluid comprises a flue gas.
